(19) United States
(12) Patent Application Publication
(10) Pub. No.: US 2011/0077798 A1
(43) Pub. Date: Mar. 31, 2011

(54) ESTIMATED ACCELERATION CALCULATING APPARATUS

(75) Inventors: Takeshi NISHIZAWA, Chiryu-shi (JP); Toshihisa Kato, Handa-shi (JP)

(73) Assignee: ADVICS CO., LTD., Kariya-shi (JP)

(21) Appl. No.: 12/890,369

(22) Filed: Sep. 24, 2010

(30) Foreign Application Priority Data
Sep. 25, 2009 (JP) 2009-220857

(51) Int. Cl. G06F 19/00

(52) U.S. Cl. 701/1

(57) ABSTRACT

An estimated acceleration calculating apparatus is provided. The apparatus includes a rolling resistance coefficient calculating unit which calculates a rolling resistance coefficient corresponding to a rough road level or a turning level of the vehicle; and an estimated acceleration calculating unit which calculates an estimated acceleration based on a motion equation, the motion equation expressing an equilibrium of wheel forces and including a term of the rolling resistance coefficient.

### CROSS REFERENCE TO RELATED APPLICATIONS

This application is based on and claims priority under 35 U.S.C. §119 to Japanese Patent Application 2009-220857, filed on Sep. 25, 2009, the entire content of which is incorporated herein by reference.

### BACKGROUND

1. Field of the Invention

The present invention relates to an estimated acceleration calculating apparatus which calculates an estimated acceleration (hereinafter, referred to as an “estimated G”) to be used in a vehicle motion control or the like.

2. Description of Related Art

When running resistance is calculated based on a wheel motion equation, an error occurs due to slipping of a wheel. Therefore, JP-A-2006-2806 proposes a running resistance sensing device which can reduce the error by executing correction according to the wheel slipping. In this running resistance sensing device, specifically, a braking force is estimated based on a brake fluid pressure or a brake pedal force, an amount of slip is calculated from the rotation speed difference between wheels having the maximum rotation number and the minimum number among four wheels, and a correction coefficient for correcting the braking force is set based on the amount of slip. Then, a gradient resistance is detected based on a driving force, an acceleration resistance, an air-rolling resistance, and the braking force that is corrected by the correction coefficient.

In the meantime, JP-A-2001-328516 proposes a road surface state discriminating device for a vehicle which can discriminate between a sandy road surface and a pressurized snow road surface both of which have the same friction coefficient indicating the surface state of a road on which a vehicle is running. The road surface state is characterized by two parameters including a rolling resistance and a road surface gradient (pseudo maximum friction coefficient) corresponding to the gradient of a μ-s characteristics curve which indicates the relationship between a friction coefficient μ and a slip ratio at the vicinity of the slip ratio of 0. Accordingly, the road surface state discriminating device discriminates a sandy road surface and a pressurized snow road surface based on these parameters.

While the running resistance sensing device described in JP-A-2006-2806 calculates running resistance by correcting the braking force, an error occurs when a vehicle is on a rough road or turning state, so that it is difficult to calculate a precise running resistance. Therefore, when calculating an estimated G based on rolling resistance corresponding to the running resistance, it is difficult to calculate the estimated G with high precision since a precise running resistance is not available.

Therefore, it may be considered that the vehicle motion control is performed only based on an estimated G obtained in a condition where the running resistance can be calculated appropriately, and when detecting a rough road or turning state of a vehicle, the calculation of the estimated G is not performed. However, in a case of performing the vehicle motion control based on a more precise final estimated G which is determined from a plurality of pieces of estimated G calculated over a certain time period, the number of pieces of estimated G which is obtained only in the condition where the running resistance can be appropriately calculated is relatively small, so that the final estimated G calculated based on that estimated G cannot be determined with sufficiently high precision.

For example, in performing control of preventing lateral overturning according to a loading amount, it can be considered to use the estimated G for calculating the loading amount. In this case, since the loading amount change only while the vehicle is not running and the loading amount does not change while running, it is important to determine the precise loading amount as early as possible after the vehicle starts running in order to effectively perform the control of preventing lateral overturning appropriately at an early stage. Particularly in this case, it is advantageous to calculate and collect the precise estimated G as much as possible irrespective of the running condition.

In addition, while the road surface state discriminating device described in JP-A-2001-328516 can discriminate between a sandy road surface and a pressurized snow road surface having the same friction coefficient μ, the device is not for calculating an estimated G with high precision based on the discrimination.

### SUMMARY

According to an aspect of the present invention, there is provided an estimated G calculating apparatus which can calculate an estimated G with high precision by reducing an error depending on the road surface state or the turning state of a vehicle.

According to an illustrative embodiment of the present invention, there is provided an estimated acceleration calculating apparatus comprising: a rough road determining unit (110) which determines a rough road level indicating a surface state of a road on which a vehicle is running; a rolling resistance coefficient calculating unit (140, 170) which calculates a rolling resistance coefficient (fr) corresponding to the rough road level; and an estimated acceleration calculating unit (180) which calculates an estimated acceleration based on a motion equation, the motion equation expressing an equilibrium of wheel forces and including a term of the rolling resistance coefficient.

According to the above, the estimated G is obtained by calculating the rolling resistance coefficient corresponding to the rough road level, and using the rolling resistance coefficient calculated corresponding to the rough road level as a rolling resistance coefficient used in the motion equation. Therefore, it is possible to calculate the estimated G based on a precise rolling resistance coefficient corresponding to the rough road level, and thus the estimated G can be calculated with high precision while taking the rough road level into consideration.

The above estimated acceleration calculating apparatus may further include a turning level calculating unit (160) which calculates a turning level indicating a degree of a turning state of the vehicle. The rolling resistance coefficient calculating unit may correct a preset default value based on the rough road level and the turning level to calculate the rolling resistance coefficient (fr).

According to the above, the estimated G is calculated using the rolling resistance coefficient which is obtained by correcting the preset default value based on the rough road level and the turning level as the rolling resistance coefficient used in the motion equation. Therefore, it is possible to calculate the estimated G based on the rolling resistance coefficient corresponding to the rough road level and the turning state of the vehicle, and thus the estimated G can be calculated with high precision while taking the rough road level and the turning state of the vehicle into consideration.

For example, the rolling resistance coefficient calculating unit may use the rolling resistance coefficient at a smooth road as the default value, and multiply the default value by a correction gain which is provided for each rough road level with respect to the smooth road to calculate a corrected rolling resistance coefficient, and the estimated acceleration calculating unit may use the corrected rolling resistance coefficient as the rolling resistance coefficient calculated by the rolling resistance coefficient calculating unit to calculate the estimated acceleration.

According to another illustrative embodiment, there is provided an estimated acceleration calculating apparatus comprising: a turning level calculating unit (160) which calculates a turning level indicating a degree of a turning state of a vehicle; a rolling resistance coefficient calculating unit (160, 170) which calculates a rolling resistance coefficient (fr) corresponding to the turning level; and an estimated acceleration calculating unit (180) which calculates an estimated acceleration based on a motion equation, the motion equation expressing an equilibrium of wheel forces and including a term of the rolling resistance coefficient.

According to the above, the rolling resistance coefficient corresponding to the turning level is calculated, and the estimated G is calculated using the rolling resistance calculated corresponding to the turning level as the rolling resistance coefficient used in the motion equation. Therefore, it is possible to calculate the estimated G based on a precise rolling resistance coefficient corresponding to the turning state of the vehicle, thereby calculating the estimated G with high precision by adding the turning state of the vehicle thereto.

It is noted that the symbols in the brakes of the respective units indicate the relationship corresponding to specific unit described in the Detailed Description.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a view showing a block diagram of an estimated G calculating apparatus according to a first illustrative embodiment of the present invention;

FIGS. 2A and 2B are schematic views showing the state where a vehicle is running, specifically, FIG. 2A shows a state where a vehicle acceleration b [m/s²] occurs, and FIG. 2B shows the relationship of respective forces occurring in one wheel in the state of FIG. 2A;

FIG. 3 is a flowchart showing a process of calculating an estimated G, executed by the estimated G calculating apparatus; and

FIG. 4 is a schematic view showing the relationship between an amplitude of a differential value DVw of a wheel velocity Vw and threshold values for respective rough road levels.

### DETAILED DESCRIPTION

Hereinafter illustrative embodiments of the present invention will be described with reference to the drawings.

### First Illustrative Embodiment

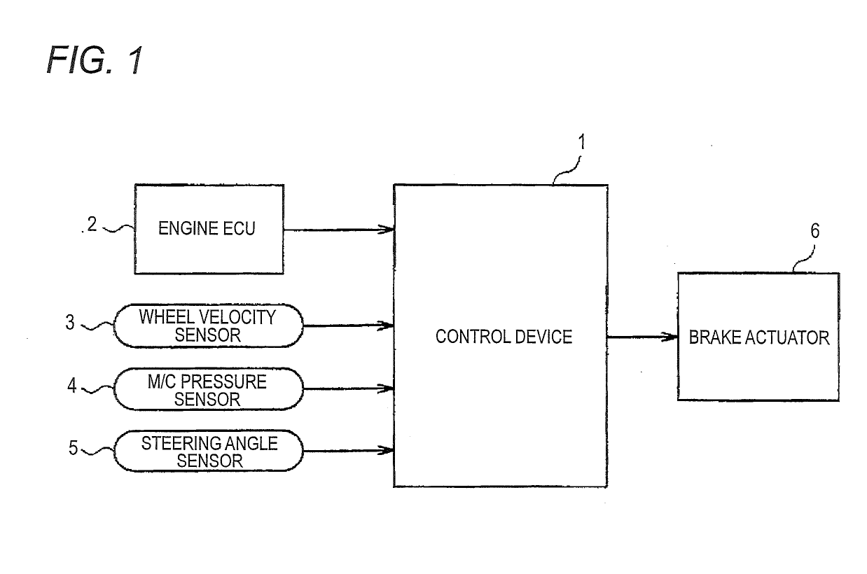

A first illustrative embodiment of the present invention will now be described. FIG. 1 is a view showing a block diagram of an estimated G calculating apparatus according to the first illustrative embodiment of the present invention.

As shown in FIG. 1, the estimated G calculating apparatus includes a control device 1. The control device calculates an estimated G which is an estimated value of acceleration of a vehicle in a forward-backward direction. Specifically, the control device 1 includes an electronic control device for a brake (a brake ECU) or the like, and is configured by a known microcomputer having a CPU, ROM, RAM, I/O, or the like. The control device 1 is configured to receive detection signals from an engine ECU 2, a wheel velocity sensor 3 which detects a wheel velocity of each of wheels, an M/C pressure sensor 4 which detects a brake fluid pressure (M/C pressure) generated by a master cylinder (M/C) and a steering angle sensor 5. The control device 1 calculates an estimated G by executing various calculations based on programs stored in the ROM or the like using the signals input from the sensors.

Before describing the calculation of an estimated G executed by the control device 1, a method of calculating an estimated G according to this illustrative embodiment will be described.

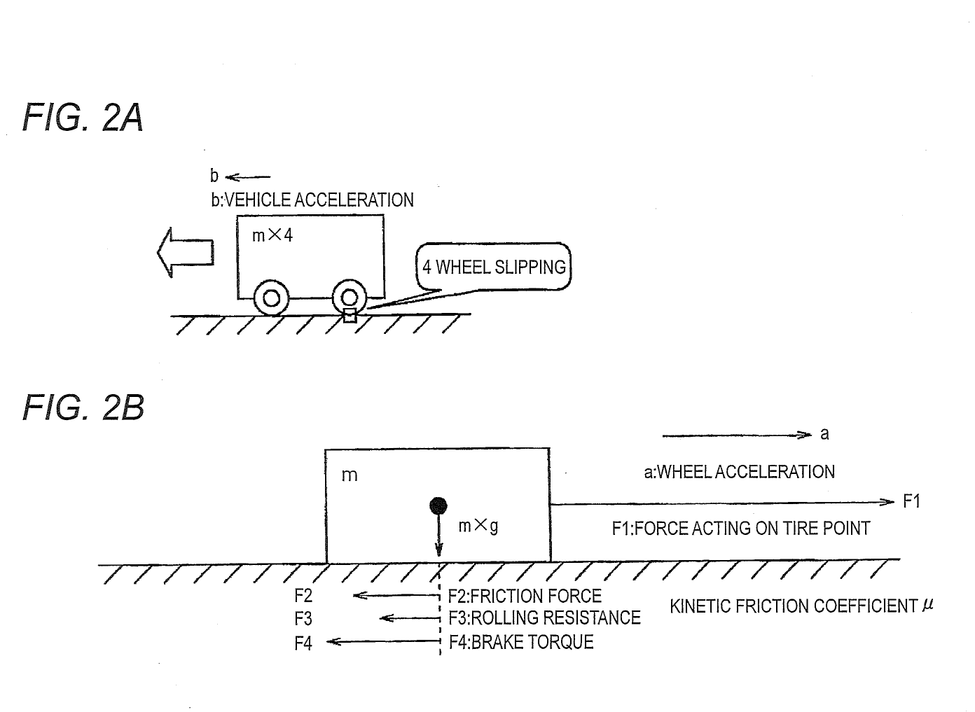

FIGS. 2A and 2B are schematic views showing the state where a vehicle is running. Specifically, FIG. 2A shows the state where a vehicle acceleration b [m/s²] occurs, and FIG. 2B shows the relationship of respective forces occurring in one wheel in the state of FIG. 2A.

Here, the weight applied to each wheel (tire) when a vehicle is empty is denoted by m [kg], the acceleration of gravity is denoted by g [m/s²], and a wheel acceleration is denoted by a [m/s²]. The total weight of the vehicle is 4×m as shown in FIG. 2A since the total weigh is a total of the weight applied to four wheels. A force applied to each wheel in the vertical direction is m×g [N].

At this time, forces applied onto the wheel include a force F1 acting on a tire point, a friction force against the road surface (i.e., a repulsive force of a tire) F2, a rolling resistance F3, and a brake torque F4. The following relationship is satisfied among these forces while assuming that an AT torque ratio denotes a torque ratio of a transmission in an automatic vehicle, a gear ratio denotes a value determined for a respective gear position of the transmission, a differential ratio denotes a ration of a differential gear, and a transfer efficiency denotes the transfer efficiency of a force in the entire drive system. Additionally, μ denotes a kinetic friction coefficient of a tire, f denotes a rolling resistance coefficient, μ′ denotes a friction coefficient of a brake pad, and N denotes a force applied to the brake pad.

F1=(Engine torque×AT torque ratio×Gear ratio×Differential ratio×Transfer efficiency)/Radius of tire (Equation 1)

F2=μ×m×g (Equation 2)

F3=f×m×g (Equation 3)

F4=(μ′×N)/Radius of tire (Equation 4)

Among these values, variable values such as an engine torque or a gear position for determining a gear ratio can be obtained by acquiring data from the engine ECU 2. Fixed values can be obtained by storing them in RAM in advance or acquiring related data from the engine ECU 2.

Assuming that the inertia of a tire and an engine is denoted by I [kg·m²] and the angular acceleration of a wheel is denoted by ω [G], respective forces in Equations 1 to 4 above are expressed by the following equation, that is, the motion equation expressing the equilibrium of forces on a wheel (wheel forces).

F1−(F2+F3+F4)=I×ω/Radius of tire (Equation 5)

When Equations 1 to 4 are substituted into Equation 5, Equation 6 can be obtained. When this equation is rearranged to for the friction coefficient μ, Equation 7 can be obtained. The friction coefficient μ is obtained by dividing a force of friction by the total vehicle weight. Among the vehicle driving force, those used for driving tires are only up to the frictional force between the road surface and the tire. Thus, the friction coefficient μ is a value obtained by dividing the driving force by the total vehicle weight, i.e., a value corresponding to the acceleration of the vehicle in the forward-backward direction. Therefore, it is possible to calculate an estimated G by calculating μ of Equation 7.

(Engine torque×AT torque ratio×Gear ratio×Differential ratio×Transfer efficiency)/Radius of tire−((μ×m×g)+(f×m×g)+(μ′×N)/Radius of tire)=I×ω (Equation 6)

μ=(Engine torque×AT torque ratio×Gear ratio×Differential ratio×Transfer efficiency)/(Radius of tire×m×g)−(I×ω/Radius of tire)/(m×g)−f−(μ′×N)/(m×g×Radius of tire) (Equation 7)

As seen from the above Equation 7, the rolling resistance F3 is calculated in order to calculate the estimated G, and the rolling resistance coefficient f is used in the calculation of rolling resistance F3. Herein, the rolling resistance F3 varies depending on the road surface state or the turning state of the vehicle. By correcting the rolling resistance coefficient f according to the road surface state or the turning state, it is possible to calculate precise rolling resistance F3 according to the road surface state or the turning state of the vehicle. Therefore, in this illustrative embodiment, the estimated G is calculated by detecting the road surface state or the turning state of the vehicle, setting the rolling resistance coefficient f based on the road surface state or the turning state of the vehicle, and using the set the rolling resistance coefficient.

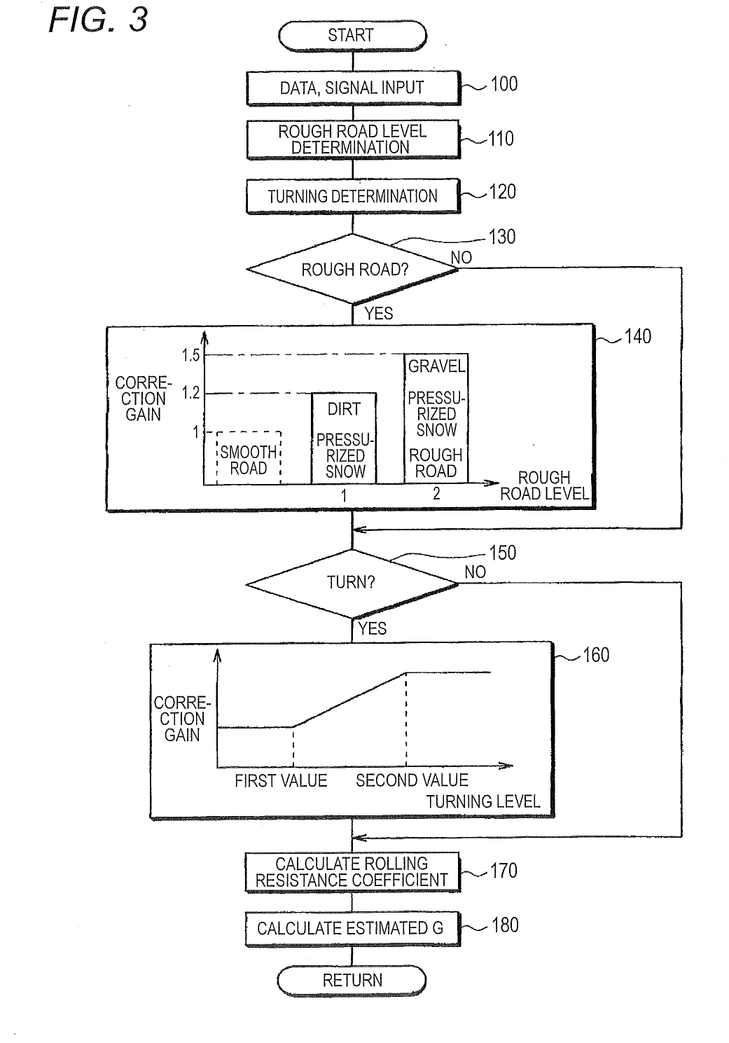

FIG. 3 is a flowchart showing a process of calculating an estimated G, executed by the estimated G calculating apparatus. The control device 1 executes the calculation of an estimated G as shown in FIG. 3 for every certain calculation period, for example, when an ignition switch is switched from the off state to the on state, or when the position of a gear is input to the D (drive) range.

First, in step 100, a signal (data) sent from the engine ECU 2 or a detection signal from the wheel velocity sensor 3, the M/C pressure sensor 4, or the steering angle sensor 5 is input.

Then, in step 110, a rough road level is determined by executing a rough road level determination. Various methods known in the art can be used for the rough road level determination. In this illustrative embodiment, the rough road level is determined, for example, as follows.

That is, in a normal running state where a vehicle acceleration is substantially 0, for example, when the state of stepping on an accelerator is in a constant velocity state which does not cause acceleration or deceleration (partial acceleration), a differential value DVw of a wheel velocity Vw is calculated and the amplitude of the differential value DVw is obtained. The amplitude of the differential value DVw is compared with a plurality of preset threshold values. Then, the rough road level is determined based on how many times and which of the threshold values the amplitude of the differential value DVw has passed in a predetermined time period (e.g., 500 ms).

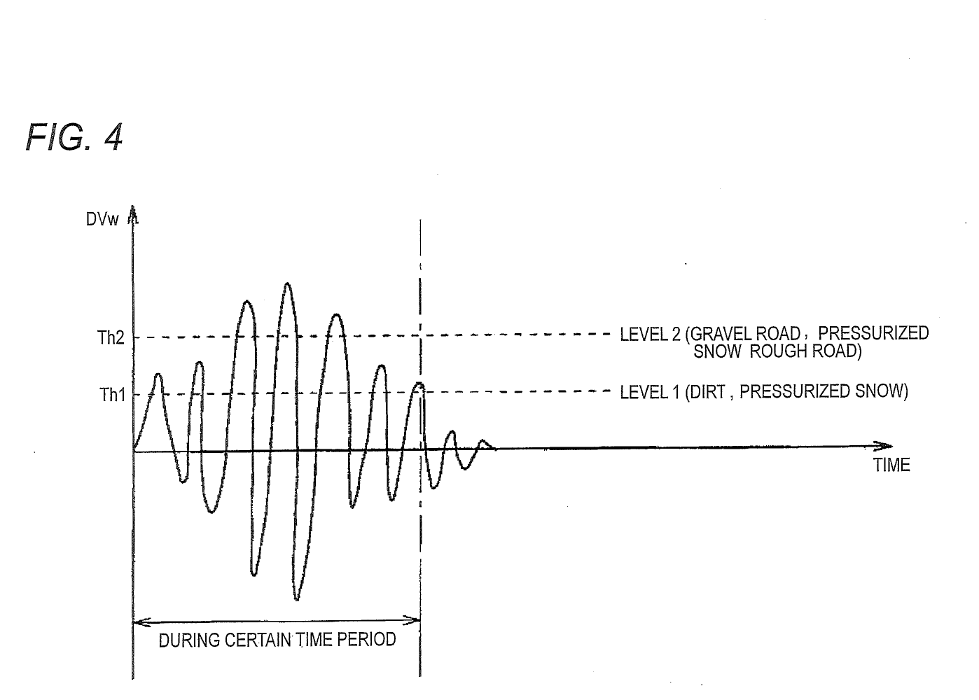

FIG. 4 is a schematic view showing the relationship between the amplitude of the differential value DVw of the wheel velocity Vw and preset threshold values for respective rough road levels. As shown in this figure, even in a normal running state, the wheel velocity Vw varies by the influence of minute protrusions and recesses on the road surface on which the vehicle is running and its differential value DVw varies. Based on whether the amplitude exceeds any one of first and second threshold values Th1 and Th2 corresponding to rough road levels 1 and 2, any one of rough road levels 1 and 2 is determined. For example, the rough road level is determined as being the rough road level 2 if the amplitude has exceeded the rough road level 2 for a predetermined number within a predetermined time. The rough road level is determined as being the rough road level 1 if the amplitude has exceeded the rough road level 1 for a predetermined number within a predetermined time even if the amplitude has not exceeded the rough road level 2 for a predetermined number. The rough road level is determined as being a rough road level 0, i.e. a smooth road, if the amplitude has not exceeded the rough road level 1 for a predetermined number within a predetermined time.

Next, in step 120, turning determination process is executed. This process includes calculating a steering angle based on a detection signal from the steering angle sensor 5. Here, the symbol of the steering angle is reversed to plus and minus, for example, in the right-left direction. However, any direction can be set to be plus.

Then, in step 130, it is determined whether the surface state of the road is rough. If the rough road level 0 is determined in above-described step 110, it is determined that the road is not rough. If any one of the rough levels 1 and 2 is determined, it is determined that the road is rough. If the road is determined to be rough, the process proceeds to Step 140. And, if the road is determined to be not rough, the process proceeds to step 150.

In step 140, correction gain of the rolling resistance coefficient f is set according to the rough road level. For example, as shown in the FIG. 3 by broken lines, in the case of a smooth road, the rolling resistance coefficient f is set to a small value compared to higher rough road level. Therefore, the rolling resistance coefficient f of the smooth road is set default, and the rolling resistance coefficient f when the rough road level is higher is subjected to correction gain with respect to the rolling resistance coefficient f of the smooth road. For example, as shown in FIG. 3, if the road state corresponding to the rough road level 1 is dirt or pressurized snow, the correction gain of the rolling resistance coefficient f is set 1.2. If the road state corresponding to rough road level 2 is gravel or pressurized snow rough road, the correction gain of the rolling resistance coefficient f is set 1.5. Here, “dirt” indicates the road surface of sandy having protrusions and recesses smaller than gravel, and “pressurized snow rough road” indicates the road surface having protrusions and recesses greater than usual in the road surface on which snow is pressurized.

Accordingly, the correction gain of the rolling resistance coefficient f corresponding to each of the rough road levels can be calculated.

Then, in step 150, it is determined whether the vehicle is turning state. This process determines whether the steering angle calculated in step 120 exceeds a predetermined range, i.e., the absolute value of the steering angle exceeds a predetermined threshold value. If the steering angle exceeds the predetermined range (i.e., the absolute value of the steering angle exceeds the predetermined threshold value), it is determined the turning state. If it is determined that the vehicle is turning state, the process proceeds to step 160. If it is determined that the vehicle is not turning state, the process proceeds to step 170.

In step 160, the turning level is calculated, and the correction gain of the rolling resistance coefficient f corresponding to the turning level is set. Herein, the turning level is a value corresponds to the absolute value of the steering angle and indicates a degree of the tuning state of the vehicle. The turning level becomes higher if the absolute value of the steering angle is greater. Specifically, the relationship between the turning level and the correction gain is set so that the correction gain increases as the turning level becoming higher. The correction gain is obtained using the map expressing the relationship as shown in FIG. 3 or a function equation corresponding to the relationship.

It is noted that the rolling resistance is not significantly influenced if the turning level is a certain small value, and the degree of influence on the rolling resistance does not change significantly if the turning level reaches a certain value. Therefore, if the turning level is a first value or smaller, the correction gain is set 1. The correction gain is changed corresponding to the turning level only when the turning level is from the first value to a second value. If the turning level is the second value or more, the correction gain becomes a constant value again.

Then, in step 170, the rolling resistance coefficient is calculated. Specifically, since the rolling resistance coefficient f of smooth road is set default, the correction gain obtained in steps 140 and 160 is multiplied by the default value. Accordingly, it is possible to calculate the actual rolling resistance coefficient fr (hereinafter, referred to as corrected rolling resistance coefficient fr) to the road surface on which the vehicle is running.

Once the corrected rolling resistance coefficient fr is obtained, in step 180, the estimated G is calculated based on the signals input in step 100 and the corrected rolling resistance coefficient fr calculated in step 170. Methods of calculating the estimated G are as described above.

Specifically, the engine torque, the AT torque ratio, the gear ratio, the differential ratio, the transfer efficiency, and the like of various parameters used in the calculation of the estimated G are input from the engine ECU 2. The steering wheel acceleration ω is calculated by executing time differentiation to a wheel velocity detected based on a detection signal from the wheel velocity sensor 3. The force N applied to the pad becomes a value corresponding to a wheel cylinder pressure (hereinafter, referred to as a W/C pressure). Since the M/C pressure becomes a value corresponding to the W/C pressure, the force N applied to the pad is calculated from a detection signal from the M/C pressure sensor 5.

The respective parameters obtained as described above are substituted into Equation 7 while the corrected rolling resistance coefficient fr is used as f in Equation 7. Accordingly, it is possible to calculate the estimated G while taking the rough road level or the turning state of the vehicle into consideration.

As described above, the estimated G calculating apparatus according this illustrative embodiment corrects the rolling resistance coefficient f according to the rough road level or the turning level, and calculates the estimated G using the corrected rolling resistance coefficient fr as the rolling resistance coefficient f used in the motion equation. Therefore, it becomes possible to calculate the estimated G based on the rolling resistance coefficient f which is corrected according to the rough road level or the turning level, so that the estimated G can be calculated with high precision while taking the rough road level or the turning state of the vehicle into consideration.

In the related art, an acceleration sensor which detects a forward-backward acceleration is provided for controlling a slip ratio in a vehicle motion control by a vehicle motion control device such as a control device for preventing lateral slip, a control device for preventing lateral overturning, an ABS control device, or the like. According to the illustrative embodiment, since the estimated G can be calculated with high precision, it is possible to perform vehicle motion control using the estimated G instead of a value detected by the acceleration sensor. Therefore, the vehicle motion control can be performed without providing the acceleration sensor. In particular, a four wheel driving vehicle is required to provide the acceleration sensor since a cascade lock in which all of the four wheels are locked would occur in some cases, and it has been impossible to precisely obtain the estimated velocity of the vehicle without the acceleration sensor. However, if the estimated G is precisely obtained as in this illustrative embodiment, the estimated G can be used instead of the value detected by the acceleration sensor. Accordingly, it is possible to omit the acceleration sensor, thereby reducing the number of parts.

For example, considering a case of performing control of preventing lateral overturning according to a loading amount, the loading amount might be changed while the vehicle is not running. Therefore, it is advantageous to calculate and store the estimated G as much as possible at an early stage after the vehicle starts running, irrespective of the running condition, that is, whether the vehicle is running on rough road or turning state. And, the precise loading amount is calculated based on the plurality of pieces of estimated G, and is utilized for the control of preventing lateral overturning at an early stage, so that the control of preventing lateral overturning according to the loading amount can be performed from an early stage after the vehicle starts running, that is, after the time when the loading amount could be changed.

Even if the acceleration sensor is provided, the reliability of a value detected by the acceleration sensor may be lowered due to the malfunctioning of the sensor or the like. In this case, it is possible to execute the various vehicle motion control or the like using the estimated G instead of a value detected by the acceleration sensor with lowered reliability.

### Other Illustrative Embodiments

While the above illustrative embodiment has been described with respect to the case in which an estimated G calculated by the estimated G calculating apparatus is used to control a slip ratio in the vehicle motion control, the estimated G can be used for other applications. For example, if the resistance value of the rolling resistance itself is calculated based on Equation 3, it is possible to calculate the running resistance of a vehicle and calculate the estimated velocity of the vehicle based on the estimated G.

In the above illustrative embodiment, signals detected by the steering sensor 5 is used in order to detect the turning state of the vehicle or signals detected by the M/C pressure sensor 4 is used in order to detect a force N applied to the pad, other signals can be used. For example, as to the turning state of the vehicle, a signal detected by a yaw rate sensor can be used. In addition, as to the force applied to the pad, the W/C pressure can be detected directly, or calculation can be executed based on the stork onto a brake pedal.

Furthermore, while the above illustrative embodiment describes an example of the method of determining a rough road level indicating the surface state of the road on which the vehicle is running, other methods can of course be used.

Herein, the steps shown in the respective figures correspond to units for executing various operations. That is, the section of executing step 110 corresponds to a rough road level determining unit, and the section of executing steps 140, 160, and 170 corresponds to a rolling resistance coefficient calculating unit, and the section of executing step 180 corresponds to an estimated G calculating unit.

What is claimed is:

1. An estimated acceleration calculating apparatus comprising:
a rough road determining unit which determines a rough road level indicating a surface state of a road on which a vehicle is running;
a rolling resistance coefficient calculating unit which calculates a rolling resistance coefficient corresponding to the rough road level; and
an estimated acceleration calculating unit which calculates an estimated acceleration based on a motion equation, the motion equation expressing an equilibrium of wheel forces and including a term of the rolling resistance coefficient.

2. The estimated acceleration calculating apparatus according to claim 1, further comprising:
a turning level calculating unit which calculates a turning level indicating a degree of a turning state of the vehicle,
wherein the rolling resistance coefficient calculating unit corrects a preset default value based on the rough road level and the turning level to calculate the rolling resistance coefficient.

3. The estimated acceleration calculating apparatus according to claim 2,
wherein the rolling resistance coefficient calculating unit uses the rolling resistance coefficient at a smooth road as the default value, and multiplies the default value by a correction gain which is provided for each rough road level with respect to the smooth road to calculate a corrected rolling resistance coefficient, and
wherein the estimated acceleration calculating unit uses the corrected rolling resistance coefficient as the rolling resistance coefficient calculated by the rolling resistance coefficient calculating unit to calculate the estimated acceleration.

4. The estimated acceleration calculating apparatus according to claim 1,
wherein the rolling resistance coefficient calculating unit uses the rolling resistance coefficient at a smooth road as the default value, and multiplies the default value by a correction gain which is provided for each rough road level with respect to the smooth road to calculate a corrected rolling resistance coefficient, and
wherein the estimated acceleration calculating unit uses the corrected rolling resistance coefficient as the rolling resistance coefficient calculated by the rolling resistance coefficient calculating unit to calculate the estimated acceleration.

5. An estimated acceleration calculating apparatus comprising:
a turning level calculating unit which calculates a turning level indicating a degree of a turning state of a vehicle;
a rolling resistance coefficient calculating unit which calculates a rolling resistance coefficient corresponding to the turning level; and
an estimated acceleration calculating unit which calculates an estimated acceleration based on a motion equation, the motion equation expressing an equilibrium of wheel forces and including a term of the rolling resistance coefficient.
